(19) United States
(12) Patent Application Publication
(10) Pub. No.: US 2025/0199554 A1
(43) Pub. Date: Jun. 19, 2025

(54) WIDE-INPUT RANGE FAULT-TOLERANT CLAMPED REGULATOR

(71) Applicant: Cirrus Logic International Semiconductor Ltd., Edinburgh (GB)

(72) Inventors: Christopher M. DOUGHERTY, Austin, TX (US); Seung Bae LEE, Austin, TX (US); Brendan T. DEEMS, Austin, TX (US); Eric J. KING, Austin, TX (US); Anindya BHATTACHARYA, Austin, TX (US)

(73) Assignee: Cirrus Logic International Semiconductor Ltd., Edinburgh (GB)

(21) Appl. No.: 18/904,657

(22) Filed: Oct. 2, 2024

Related U.S. Application Data
(60) Provisional application No. 63/609,556, filed on Dec. 13, 2023.

(51) Int. Cl. G05F 1/575

(52) U.S. Cl. CPC G05F 1/575

(57) ABSTRACT

A voltage regulator may be configured to receive an input voltage at an input and generate an output voltage at an output. The voltage regulator may include a plurality of pass devices coupled in series between the input and the output, wherein a first device of the plurality of pass devices is closer to the input than the other of the plurality of pass devices embedded within a feedback loop of the voltage regulator and a gate bias network configured to bias gates of the plurality of pass devices such that the plurality of pass devices act as a single series device within a first voltage range of the input voltage and act as a series stack of cascode devices with the first device acting as a voltage-controlled current source within a second voltage range of the input voltage higher than the first voltage range and the output voltage is in a protected voltage domain immune from high-voltage transients of the input voltage.

### RELATED APPLICATION

The present disclosure claims priority to U.S. Provisional Patent Application Ser. No. 63/609,556, filed Dec. 13, 2023, which is incorporated by reference herein in its entirety.

### FIELD OF DISCLOSURE

The present disclosure relates in general to circuits for electronic devices, including without limitation personal audio devices such as wireless telephones and media players, and more specifically, a fault-tolerant, clamped voltage regulator having a wide input range.

### BACKGROUND

Portable electronic devices, including wireless telephones, such as mobile/cellular telephones, tablets, cordless telephones, mp3 players, smart watches, health monitors, and other consumer devices, are in widespread use. Such a portable electronic device may include a battery (e.g., a lithium-ion battery) for powering components of the portable electronic device. Typically, such batteries used in portable electronic devices are rechargeable, such that when charging, the battery converts electrical energy into chemical energy which may later be converter back into electrical energy for powering components of the portable electronic device.

Battery-based systems must have protection against high-voltage transients that occur in fault conditions when using a battery charger. Existing protection schemes rely heavily on detection of the fault and a quick shutdown of the battery management system upon occurrence. These schemes have fundamental issues including: (a) latency, which varies from system to system and may be too long to protect low-voltage circuitry, and (b) forcing a system to go into a shutdown mode typically without properly alerting the host device(s). Also, many solutions depend on use of specialized high-voltage semiconductor processes, adding to overall cost of protection during fault, and often use clamp circuits that consume high currents continuously during the fault case.

### SUMMARY

In accordance with the teachings of the present disclosure, one or more disadvantages and problems associated with existing approaches to battery protection may be reduced or eliminated.

In accordance with embodiments of the present disclosure, a voltage regulator may be configured to receive an input voltage at an input and generate an output voltage at an output and the voltage regulator may include a plurality of pass devices coupled in series between the input and the output, wherein a first device of the plurality of pass devices is closer to the input than the other of the plurality of pass devices embedded within a feedback loop of the voltage regulator and a gate bias network configured to bias gates of the plurality of pass devices such that the plurality of pass devices act as a single series device within a first voltage range of the input voltage and act as a series stack of cascode devices with the first device acting as a voltage-controlled current source within a second voltage range of the input voltage higher than the first voltage range and the output voltage is in a protected voltage domain immune from high-voltage transients of the input voltage.

In accordance with these and other embodiments of the present disclosure, a method may include series coupling a plurality of pass devices between an input and an output of a voltage regulator configured to receive an input voltage at the input and generate an output voltage at the output, such that a first device of the plurality of pass devices is closer to the input than the other of the plurality of pass devices embedded within a feedback loop of the voltage regulator. The method may also include biasing, with a gate bias network, gates of the plurality of pass devices such that the plurality of pass devices act as a single series device within a first voltage range of the input voltage and act as a series stack of cascode devices with the first device acting as a voltage-controlled current source within a second voltage range of the input voltage higher than the first voltage range and the output voltage is in a protected voltage domain immune from high-voltage transients of the input voltage.

Technical advantages of the present disclosure may be readily apparent to one skilled in the art from the FIGURES, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawing, in which like reference numbers indicate like features, and wherein:

FIGS. 1A and 1B (which may be referred to herein collectively as “FIG. 1”) illustrate selected components of an example wide-input range fault-tolerant clamped regulator, in accordance with embodiments of the present disclosure.

### DETAILED DESCRIPTION

Embodiments of the present disclosure may provide wide input-range fault-tolerant clamped regulation and voltage protection against high-voltage transients in battery management applications without significant latency and avoid use of a fully-dedicated high-voltage semiconductor process by distributing the overall high fault voltage over a collection of low voltage devices. Simultaneously, the output voltage of the regulator may be held steady during the fault, keeping downstream low-voltage circuitry undisturbed and operational throughout. Furthermore, battery loading may not sufficiently change under the fault condition or even when the battery voltage falls to extremely low levels.

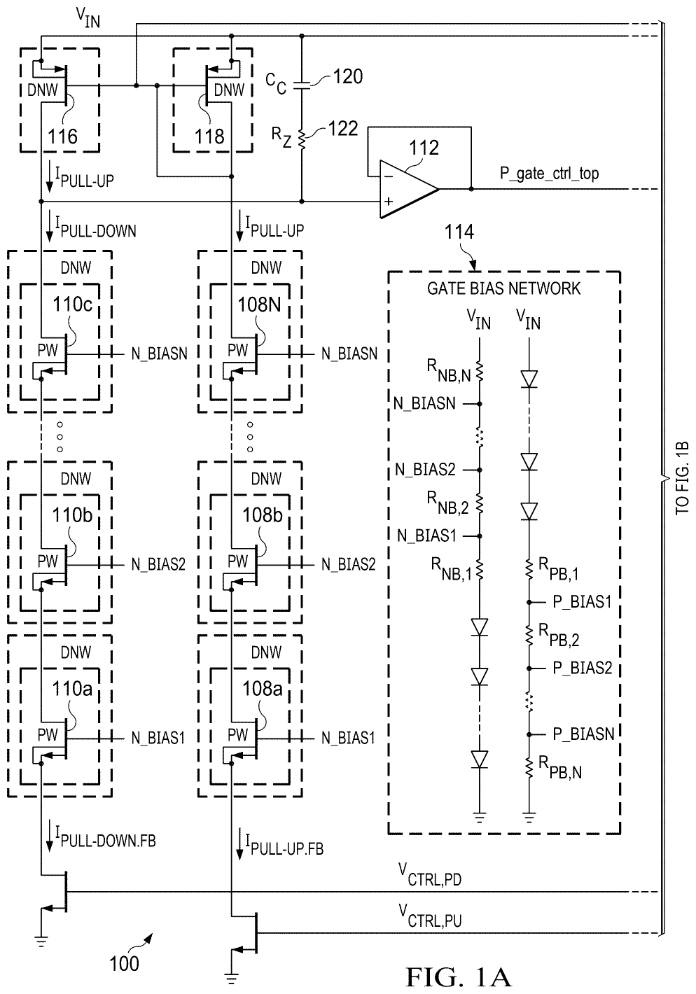

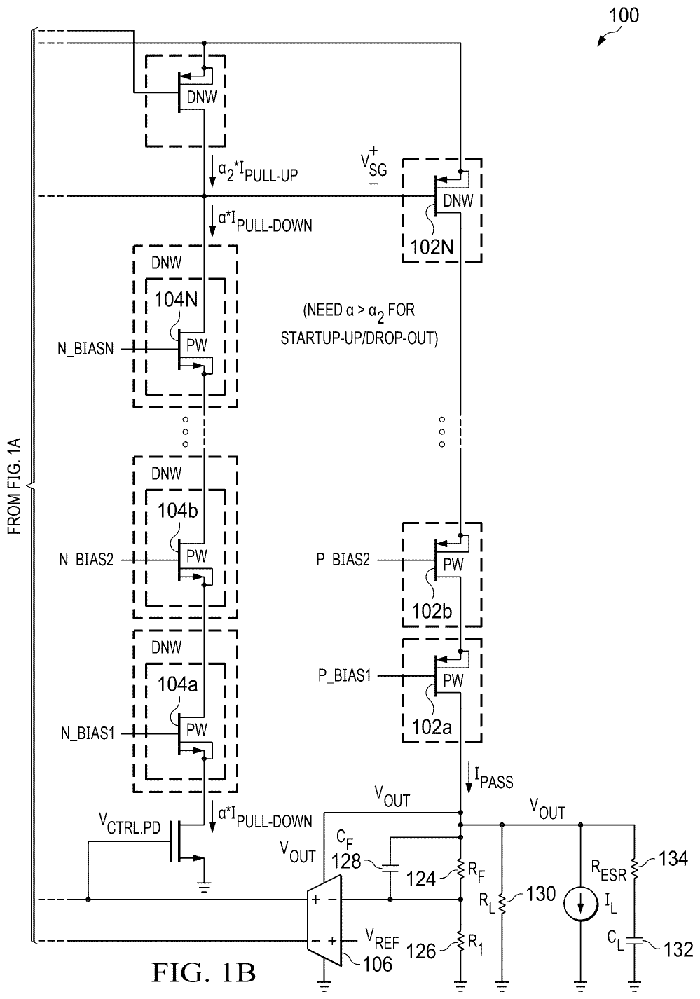

FIG. 1 illustrates selected components of an example wide-input range fault-tolerant clamped regulator 100, in accordance with embodiments of the present disclosure.

As shown in FIG. 1, regulator 100 may receive an input voltage V_{IN}, for example from a battery. As an example, such battery may apply a nominal input voltage V_{IN} of 4 volts. In operation, regulator 100 may generate from input voltage V_{IN} a clamped output voltage V_{OUT} at a lower level than input voltage V_{IN} (e.g., 3 volts). Such output voltage V_{OUT} may serve as a power supply for circuits powered by the battery, including both analog and digital blocks requiring safely limited supply voltage.

For fault conditions (e.g., fault conditions associated with battery charging), very high voltages (e.g., ≈50 volts) may occur on input voltage V_{IN}, but regulator 100 may clamp output voltage V_{OUT} such that it is largely unaffected by the fault condition on input voltage V_{IN}. Alternatively, with a nearly discharged battery and extreme loading, input voltage V_{IN} may fall to very low voltages (e.g., 2 volts or lower) and regulator 100 may pass input voltage V_{IN} to output voltage V_{OUT} directly with very little “drop-out” voltage. This wide input-range behavior may be safely accomplished using devices with individual gate-source voltage (“V_{GS}”) and drain-source voltage (“V_{DS}”) ratings much lower than the maximum input voltage V_{IN}. Proper distribution of the large potential over this collection of devices is achieved by dynamically biasing isolation wells, labeled in FIG. 1 with “DNW” for deep N-wells and “PW” for isolated P-wells and “stacking” a sufficient number of cascoded protection transistors having such deep N-wells and isolated P-wells as shown in FIG. 1 and described below.

The primary power path for a current I_{PASS} may occur through a plurality of P-channel metal-oxide semiconductor (PMOS) field-effect transistor pass devices 102a, 102b, through 102N. The top-most PMOS pass device 102N (e.g., the PMOS pass device coupled closest to input voltage V_{IN}) may operate in effect as a voltage-controlled current source, while PMOS pass devices 102 other than PMOS pass device 102N may function primarily as cascodes. A gate voltage P_GATE_CTRL_TOP of PMOS pass device 102N may be controlled by a feedback loop that traverses various voltage domains through a plurality of N-channel metal-oxide semiconductor (NMOS) field-effect transistor cascodes 104a, 104b, through 104N, with gate voltages labeled N_BIAS1 through N_BIASN. A primary error amplifier 106 may be powered by output voltage V_{OUT} and may include low-voltage devices. For push-pull symmetry, error amplifier 106 may generate dual output control voltages V_{CTRL,PD} and V_{CTRL,PU} through a stack of pull-up cascodes 108a, 108b, through 108N and a stack of pull-down cascodes 110a, 110b, and 110N, resulting in feedback currents I_{PULL-UP} and I_{PULL-DOWN}, to actively pull up or pull-down gate voltage P_GATE_CTRL_TOP (loaded by a gate capacitance of PMOS pass device 102N) via a buffer circuit 112 in the high-voltage domain.

A gate bias network 114 may generate the various dynamic cascode gate bias voltages (N_BIAS1 through N_BIASN and P_BIAS1 through P_BIASN) through diode-resistor strings sized to operate as a voltage divider for high levels of input voltage V_{IN} (e.g., for ˜4V<V_{IN}<˜50V), distributing the large input voltage V_{IN} approximately equally over each cascode device (e.g., devices 102, 104, 108, and 110). When input voltage V_{IN} is small (e.g., for V_{IN}<˜3V), the diodes of gate bias network 114 may turn off and cascode gate bias voltages N_BIAS1 through N_BIASN may be equal to input voltage V_{IN} for NMOS devices 104 and cascode gate bias voltages P_BIAS1 through P_BIASN may be equal to ground (e.g., 0 volts) for PMOS devices 102, 108, and 110, essentially tying together gates of cascode devices 102, 104, 108, and 110. In this low-voltage configuration, NMOS cascodes 104 may function effectively as a single “series device” with one dominant gate-source voltage V_{GS} voltage drop, leaving necessary headroom for proper “drop-out” operation. Similarly, all of PMOS pass devices 102 may be biased in their linear regions of operation and may function as a small-valued series resistance between input voltage V_{IN} and output voltage V_{OUT}.

Using the systems and methods described herein, a regulator (e.g., regulator 100) may function as a high-voltage clamp while providing constant battery loading both in or out of a fault protection mode. A stacked-pass device structure (e.g., PMOS pass devices 102) may maintain consistent gate-source voltage control values and a steady output voltage V_{OUT} when input voltage V_{IN} varies. In addition, a stacked cascode structure (e.g., NMOS cascodes 104) with proper dynamic gate bias levels (e.g., N_BIAS1 through N_BIASN) may safely distribute large input voltages V_{IN} over a collection of low-voltage devices (e.g., NMOS cascodes 104). Such bias levels may track variations in input voltage V_{IN}. At low levels of input voltage V_{IN}, the stacked cascode structure may “collapse” down to a single series device. The gate bias behavior may be accomplished using one or more diode-resistor string(s) (e.g., gate bias network 114).

Further, an error amplifier (e.g., error amplifier 106) may be supplied by the low-voltage regulated output voltage V_{OUT} net with inherent level-shifting to multiple voltage domains (via signal currents through cascode devices 108 and 110). Such feature may allow use of low-voltage devices for wider bandwidth and smaller area. Such feature may allow a second gain stage of the error amplifier (e.g., buffer 112) to be in a high-voltage domain.

Regulator 100 may also include capacitor 120 (having capacitance C_{C}) and resistor 122 (having resistance R_{Z}), which may be used as part of a frequency compensation scheme for stability and which may reside in the high-voltage domain of regulator 100, although the combination of capacitor 120 and resistor 122 may only see a single transistor gate-to-source voltage drop. Regulator 100 may also include a resistor divider comprising resistor 124 (having resistance R_{F}) and resistor 126 (having resistance R₁) that may, together with a reference voltage V_{REF} received by primary error amplifier 106, set a target for output voltage V_{OUT} when regulator 100 is in regulation (and not in drop-out). A capacitor 128 (with capacitance C_{F}) may be in parallel with resistor 124 and may bypass resistor 124 at high frequencies to maximize bandwidth and aid in frequency stability. A load driven by output voltage V_{OUT} may receive a load current I_{L}. The load may have an impedance represented by a resistor 130 (having resistance R_{L}), a capacitor 132 (having resistance C_{L}) and a resistor 134 (having resistance R_{ESR}) that is either a series resistance of capacitor 132 and/or a physical resistor which provides a zero, to aid in frequency compensation.

The protected voltage domain of the output voltage (e.g., output voltage V_{OUT}) of regulator 100 may provide protection to various signal and communication lines in an electronic system powered from the regulator. In some embodiments, regulator 100 may also be implemented using NMOS pass devices in lieu of PMOS pass devices, and whereby the circuitry of such an implementation may mostly be complementary of the PMOS pass device implementation depicted in FIG. 1. Such an NMOS pass device implementation may require charge pumps to boost the gate voltages of the pass devices. Furthermore, in these and other embodiments, implementations of regulator 100 may include native and depletion mode N/P type field-effect transistors (FETs) for pass devices.

Embodiments of the present disclosure may provide wide input-range fault-tolerant clamped regulation and voltage protection against high-voltage transients in battery management applications without significant latency and may avoid use of a fully dedicated high-voltage semiconductor process by distributing the overall high fault voltage over a collection of low-voltage devices. Simultaneously, the output voltage may be held steady during the fault, keeping downstream low-voltage circuitry undisturbed and operational throughout. Furthermore, battery loading may not not sufficiently change under the fault condition or even when the battery voltage falls to extremely low-levels.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing FIGURES and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A voltage regulator configured to receive an input voltage at an input and generate an output voltage at an output and comprising:
a plurality of pass devices coupled in series between the input and the output, wherein a first device of the plurality of pass devices is closer to the input than the other of the plurality of pass devices embedded within a feedback loop of the voltage regulator; and
a gate bias network configured to bias gates of the plurality of pass devices such that:
the plurality of pass devices act as a single series device within a first voltage range of the input voltage and act as a series stack of cascode devices with the first device acting as a voltage-controlled current source within a second voltage range of the input voltage higher than the first voltage range; and
the output voltage is in a protected voltage domain immune from high-voltage transients of the input voltage.

2. The voltage regulator of claim 1, wherein the feedback loop spans multiple voltage domains and comprises:
an error amplifier supplied by the output voltage in a first voltage domain; and
a buffer in a second voltage domain higher than the first voltage domain.

3. The voltage regulator of claim 1, wherein the gate bias network comprises a diode-resistor string configured to bias gates of the plurality of pass devices.

4. A method comprising:
series coupling a plurality of pass devices between an input and an output of a voltage regulator configured to receive an input voltage at the input and generate an output voltage at the output, such that a first device of the plurality of pass devices is closer to the input than the other of the plurality of pass devices embedded within a feedback loop of the voltage regulator; and
biasing, with a gate bias network, gates of the plurality of pass devices such that:
the plurality of pass devices act as a single series device within a first voltage range of the input voltage and act as a series stack of cascode devices with the first device acting as a voltage-controlled current source within a second voltage range of the input voltage higher than the first voltage range; and
the output voltage is in a protected voltage domain immune from high-voltage transients of the input voltage.

5. The method of claim 4, wherein the feedback loop spans multiple voltage domains and comprises:
an error amplifier supplied by the output voltage in a first voltage domain; and
a buffer in a second voltage domain higher than the first voltage domain.

6. The method of claim 4, wherein the gate bias network comprises a diode-resistor string configured to bias gates of the plurality of pass devices.
